(19) United States
(12) Patent Application Publication
(10) Pub. No.: US 2010/0010154 A1
(43) Pub. Date: Jan. 14, 2010

(54) GELS PREPARED FROM DPE CONTAINING BLOCK COPOLYMERS

(75) Inventor: DAVID JOHN ST. CLAIR, Houston, TX (US)

Correspondence Address: KRATON POLYMERS U.S. LLC, 16400 Park Row, HOUSTON, TX, 77084, US

(73) Assignee: KRATON Polymers U.S. LLC, Houston, TX (US)

(21) Appl. No.: 12/168,994

(22) Filed: Jul. 8, 2008

(51) Int. Cl. C08L 53/00

(52) U.S. Cl. 524/570; 525/88

(57) ABSTRACT

The present invention relates to gels prepared from novel anionic block copolymers of mono alkenyl arenes, diphenylethylenes and conjugated dienes, and to blends of such block copolymers with oils. The block copolymers are selectively hydrogenated and have mono alkenyl arene/diphenylethylene end blocks and conjugated diene mid blocks. The block copolymer may be combined with oils and other components to form the gels of the present invention.

### BACKGROUND OF THE INVENTION

1. Field of the Invention

The present invention relates to gels prepared from anionic block copolymers and extender oils. The anionic block copolymers comprise at least one block comprising a mixture of 1,1-diphenylethylene and its derivatives with mono alkenyl arenes and at least one block comprising a conjugated diene or conjugated diene containing mixture selected from isoprene, butadiene, or mixtures of isoprene and butadiene. Said block copolymers may be unsaturated or hydrogenated.

2. Background of the Art

The preparation of block copolymers of mono alkenyl arenes and conjugated dienes is well known. One of the first patents on linear ABA block copolymers made with styrene and butadiene is U.S. Pat. No. 3,149,182. These polymers in turn could be hydrogenated to form more stable block copolymers, such as those described in U.S. Pat. No. 3,595,942 and U.S. Re. 27,145. Such polymers are broadly termed Styrenic Block Copolymers or SBC's.

SBC's have a long history of use as adhesives, sealants and gels. A recent example of such a gel can be found in U.S. Pat. No. 7,141,621. With the increased use of oil gels, the need for improved properties (expressed in terms of higher tensile strength and higher elongation) exist. Such gels may be used, for example, as a waterproofing encapsulant/sealant for electronics and in cable applications. Many gels are deficient in that they soften too much at elevated temperatures. Accordingly, it would be helpful to have gels which when molded have higher softening points than comparable molecular weight polymers.

Now a novel anionic block copolymer based on mono alkenyl arene/diphenylethylene end blocks and conjugated diene mid blocks has been discovered. Methods for making such polymers are described in detail herein. Patentee has found that these new polymers will allow the preparation of improved oil gels. In particular, the gels have improved properties at elevated temperatures.

### SUMMARY OF THE INVENTION

The present invention relates to novel oil gel compositions comprising 100 parts by weight of at least one block copolymer composition and 300 to about 2000 parts by weight of one or more extender oils wherein the block copolymer composition comprises one or more block copolymers having at least one A polymer block and at least one B polymer block wherein the A block represents a polymer block comprising mono alkenyl arenes and one or more monomers of the formula I:

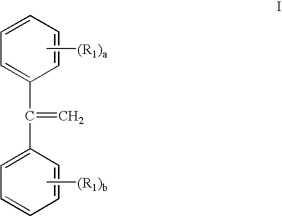

wherein R₁ is hydrogen or an alkyl of 1 to 22 carbon atoms, a is 0, 1, 2, 3, 4, or 5 and b is 0, 1, 2, 3, 4, or 5 and the B block represents a polymer block of a conjugated diene or a conjugated diene mixture. The gels of the present invention are used, for example, as a water proofing encapsulant/sealant for electronics and in cable applications, shoe inserts, toys, novelty items, cushions, rests and damping applications.

As shown in the examples which follow, gels made with the novel block copolymers have significantly higher softening points, making them useful for articles requiring greater stability at elevated temperatures. By increasing the high temperature performance, gels can be made which will maintain their shape and integrity to higher temperatures.

### DETAILED DESCRIPTION OF THE PREFERRED EMBODIMENTS

The gels of the present invention comprise a block copolymer composition in combination with one or more extender oils. The block copolymer compositions of the present invention preferably contain one or more block copolymers having a structure prior to hydrogenation of A-B, A-B-A, (A-B)ₙ, (A-B)ₙX, (A-B-A)ₙ, or (A-B-A)ₙX wherein A represents a polymer block of a mixture of one or more mono alkenyl arenes and one or more monomers of the general formula I:

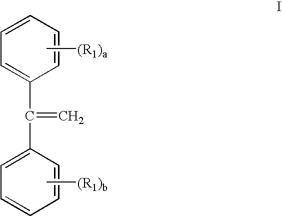

wherein R₁ is hydrogen or an alkyl of 1 to 22 carbon atoms, a is 0, 1, 2, 3, 4, or 5 and b is 0, 1, 2, 3, 4, or 5, B represents a polymer block of a conjugated diene or conjugated dienes mixture; n is an integer from 1 to 30 and X represents the residue of a coupling agent.

With regard to the various block copolymer structures, each A block represents a polymer block of a mixture of one or more mono alkenyl arenes and one or more monomers of 1,1-diphenylethylene or its derivatives. While the mono alkenyl arenes utilized may be any mono alkenyl arene known for use in the preparation of block copolymers such as styrene, o-methylstyrene, p-methylstyrene, p-tert-butylstyrene, 2,4-dimethylstyrene, alpha-methylstyrene, vinylnaphthalene, vinyltoluene and vinylxylene or mixtures thereof, the most preferred mono alkenyl arene for use in the preparation of the block copolymers of the present invention is styrene, which is used as a substantially pure monomer or as a major component in mixtures with minor proportions of other structurally related alkenyl aromatic monomer(s) such as o-methylstyrene, p-methylstyrene, p-tert-butylstyrene, 2,4-dimethylstyrene, α-methylstyrene, vinylnaphtalene, vinyltoluene and vinylxylene, i.e., in proportions of at most 10% by weight. The use of substantially pure styrene is most preferred.

In addition to the mono alkenyl arenes, each A block comprises one or more 1,1-diphenylethylenes or its derivatives, particularly of the formula I:

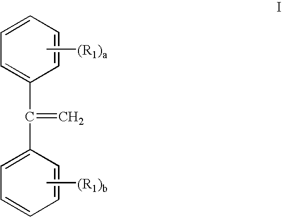

wherein R₁ is hydrogen or an alkyl of 1 to 22 carbon atoms, a is 0, 1, 2, 3, 4, or 5 and b is 0, 1, 2, 3, 4, or 5. In formula I, the aromatic rings may be substituted by an alkyl group having up to 22 carbon atoms. Preferred alkyl substituents are alkyl groups having from 1 to 4 carbon atoms such as methyl, ethyl, isopropyl, n-propyl, n-butyl, isobutyl and tert-butyl. When the aromatic rings are substituted by an alkyl group, there may be from 1 to 5 substituents. When the aromatic ring is substituted, preferably the degree of substitution will be from 1 to 3 alkyl substituents, more preferably 1. However, the unsubstituted 1,1-diphenylethylene is particularly preferred.

The weight ratio of 1,1-diphenylethylenes or its derivatives of the formula I to monoalkenyl arenes in the block copolymers is generally within the range of from 3:97 to 70:30, preferably within the range of from 15:85 to 60:40.

Each of the B blocks of the block copolymers is represented by conjugated dienes selected from butadiene, isoprene and mixtures thereof. In one embodiment of the present invention, the conjugated diene is butadiene. In an alternative embodiment, the conjugated diene is a mixture of butadiene and isoprene wherein the ratio of butadiene to isoprene is from 20:80 to 80:20. When the B polymer block comprises a mixture of butadiene and isoprene, the polymer block will be a randomly polymerized block of butadiene and isoprene.

A variety of coupling agents are known in the art and can be used in preparing the coupled block copolymers of the present invention. These include, for example, dihaloalkanes, silicon halides, siloxanes, multifunctional epoxides, esters of monohydric alcohols with carboxylic acids, (e.g. methylbenzoate and dimethyl adipate) and epoxidized oils. Star-shaped polymers are prepared with polyalkenyl coupling agents as disclosed in, for example, U.S. Pat. Nos. 3,985,830; 4,391,949; and 4,444,953; as well as Canadian Patent No. 716,645, each incorporated herein by reference. Suitable polyalkenyl coupling agents include divinylbenzene, and preferably m-divinylbenzene. Preferred are tetra-alkoxysilanes such as tetra-methoxysilane (TMOS) and tetra-ethoxysilane (TEOS), tri-alkoxysilanes such as methyltrimethoxysilane (MTMS), aliphatic diesters such as dimethyl adipate and diethyl adipate, and diglycidyl aromatic epoxy compounds such as diglycidyl ethers deriving from the reaction of bis-phenol A and epichlorohydrin.

The molecular weight of the various blocks in the block copolymers is also an important factor in preparing the oil gels of the present invention. For each A block the desired block weights are 3,000 to about 60,000, preferably about 5,000 to about 50,000. For each B block the desired block weights are about 20,000 to about 200,000, preferably about 20,000 to about 150,000. As used herein, the term “molecular weights” refers to the true molecular weight in g/mol of the polymer or block of the copolymer. The molecular weights referred to in this specification and claims can be measured with gel permeation chromatography (GPC) using polystyrene calibration standards, such as is done according to ASTM 3536. GPC is a well-known method wherein polymers are separated according to molecular size, the largest molecule eluting first. The chromatograph is calibrated using commercially available polystyrene standards of known molecular weight. The molecular weight of polymers measured using GPC so calibrated are styrene equivalent molecular weights. The styrene equivalent molecular weight may be converted to true molecular weight when the styrene content of the polymer and the vinyl content of the diene segments are known. The detector used is preferably a combination ultraviolet and refractive index detector. The molecular weights expressed herein are measured at the peak of the GPC trace, and are expressed as styrene equivalent molecular weights.

With regard to the coupled block copolymers, the Coupling Efficiency (“CE”) will typically be from about 70 to 98 weight percent, preferably about 80 to about 98 weight percent. Coupling Efficiency is defined as the proportion of polymer chain ends which were living, P—Li, at the time the coupling agent was added that are linked via the residue of the coupling agent at the completion of the coupling reaction. In practice, Gel Permeation Chromatography (GPC) data are used to calculate the coupling efficiency for a polymer product.

The percentage of A blocks in the block copolymer composition is desired to be about 5 to about 50 weight percent, preferably about 10 to about 40 weight percent.

Another important aspect of the present invention is to control the microstructure or vinyl content of the conjugated diene in the B block. The term “vinyl content” refers to a conjugated diene which is polymerized via 1,2-addition (in the case of butadiene—it would be 3,4-addition in the case of isoprene). Although a pure “vinyl” group is formed only in the case of 1,2-addition polymerization of 1,3-butadiene, the effects of 3,4-addition polymerization of isoprene (and similar addition for other conjugated dienes) on the final properties of the block copolymer will be similar. The term “vinyl” refers to the presence of a pendant vinyl group on the polymer chain. When referring to the use of butadiene as the conjugated diene, it is preferred that about 10 to about 80 mol percent of the condensed butadiene units in the copolymer block have 1,2 vinyl configuration as determined by proton NMR analysis, preferably about 25 to about 80 mol percent of the condensed butadiene units should have 1,2-vinyl configuration. Below 25% 1,2 vinyl the polymer becomes too crystalline resulting in more oil bleed-out in the gel. Above 80% 1,2 vinyl the polymer becomes inefficient at creating a gel so that more polymer must be used. When referring to the use of isoprene as the conjugated diene, it is preferred that about 5 to about 80 mol percent of the condensed isoprene units in the copolymer block have 3,4 vinyl configuration. Vinyl content is effectively controlled by varying the relative amount of the microstructure modifying agent in the solvent mixture. Such materials include ethers such as diethyl ether (DEE) or for higher vinyl contents, diethoxy propane (DEP). Suitable ratios of modifying agent to lithium are disclosed and taught in U.S. Pat. Re. 27,145, which disclosure is incorporated by reference.

The block copolymer utilized in the oil gels of the present invention may be unsaturated or selectively hydrogenated. Hydrogenation can be carried out via any of the several hydrogenation or selective hydrogenation processes known in the prior art. For example, such hydrogenation has been accomplished using methods such as those taught in, for example, U.S. Pat. Nos. 3,494,942; 3,634,594; 3,670,054; 3,700,633; and Re. 27,145. Hydrogenation can be carried out under such conditions that at least about 90 percent of the conjugated diene double bonds have been reduced, and between zero and 10 percent of the arene double bonds have been reduced. Preferred ranges are at least about 95 percent of the conjugated diene double bonds reduced, and more preferably about 98 percent of the conjugated diene double bonds are reduced. Alternatively, it is possible to hydrogenate the polymer such that aromatic unsaturation is also reduced beyond the 10 percent level mentioned above. In that case, the double bonds of both the conjugated diene and arene may be reduced by 90 percent or more.

One of the components used in the gels of the present invention is a polymer extending oil or plasticizer. Especially preferred are the types of oils that are compatible with the elastomeric segment of the block copolymer. While oils of higher aromatics content are satisfactory, those petroleum-based white oils having low volatility and less than 50% aromatic content are preferred. Such oils include both paraffinic and naphthenic oils. The oils should additionally have low volatility, preferably having an initial boiling point above about 500° F.

Examples of alternative plasticizers which may be used in the present invention are oligomers of randomly or sequentially polymerized styrene and conjugated diene, oligomers of conjugated diene, such as butadiene or isoprene, liquid polybutene-1, and ethylene-propylene-diene rubber, all having a number average molecular weight in the range from 300 to 35,000, preferable less than about 25,000 mol weight.

The amount of oil or plasticizer employed varies from about 300 to about 2000 parts by weight per hundred parts by weight rubber, or block copolymer, preferably about 400 to about 1000 parts by weight.

Various types of fillers and pigments can be included in the gel formulations to color the gel, increase stiffness and reduce cost. Suitable fillers include calcium carbonate, clay, talc, silica, zinc oxide, titanium dioxide and the like. The amount of filler usually is in the range of 0 to 30% weight based on the total formulation, depending on the type of filler used and the application for which the gel is intended. An especially preferred filler is silica.

The compositions of the present invention may be modified further with the addition of other polymers in particular polyolefins such an polyethylenes and polypropylenes, reinforcements, antioxidants, stabilizers, fire retardants, anti blocking agents, lubricants and other rubber and plastic compounding ingredients without departing from the scope of this invention. Such components are disclosed in various patents including U.S. Pat. No. 3,239,478; and U.S. Pat. No. 5,777,043, the disclosures of which are incorporated by reference.

Regarding the relative amounts of the various ingredients, this will depend in part upon the particular end use and on the particular block copolymer that is selected for the particular end use. Table A below shows some notional compositions that are included in the present invention. The block copolymer and oil amounts are expressed in parts by weight. If polyethylene or filler are used, they may be used at levels shown as a percent by weight of the polymer component.

TABLE A
Applications, Compositions and Ranges

| Application | Ingredients | Composition |
|---|---|---|
| Oil gel | Block Copolymer | 100 ppw |
| | Oil | 300 to 2000 ppw |
| | Polyethylene | 0 to 80 wt % |
| | Fillers | 0 to 30 wt % |

The oil gels or gelatinous elastomer compositions of the present invention are useful in a number of applications, including low frequency vibration applications, such as viscoelastic layers in constrained-layer damping of mechanical structures and goods, as viscoelastic layers useful for isolation of acoustical and mechanical noise, as antivibration elastic support for transporting shock sensitive loads, etc. The compositions are also useful as molded shape articles for use in medical and sport health care, such use including therapeutic hand exercising grips, crutch cushions, cervical pillows, bed wedge pillows, leg rest, neck cushion, mattress, bed pads, elbow padding, wrist rests for computers, wheelchair cushions, soft toys and the like. See, for example, U.S. Pat. No. 5,334,646.

### EXAMPLES

The following examples are provided to illustrate the present invention. The examples are not intended to limit the scope of the present invention and they should not be so interpreted. Amounts are in weight parts or weight percentages unless otherwise indicated. The test methods used in the examples are American Society for Testing Materials (ASTM) test methods, and the following specific methods were used:

| | |
|---|---|
| Melt Viscosity | ASTM D-3236 |
| Ring & Ball Softening Point | ASTM D-36 |
| Tensile Properties | ASTM D-412 |

### Example 1

The following details the synthesis of the block copolymers employed in the present invention. Table 1 below details the overall structure of the resulting polymers.

### EDF 9214

Cyclohexane (98.54 kg) was charged into a stainless steel autoclave (1). Diethyl ether (0.06 kg) was added, followed by 1,1-diphenylethylene (5.45 kg). The mixture was titrated with sec-BuLi (1.3 M) to a visual endpoint while the temperature was maintained at 50° C. Excess sec-BuLi (453 mL, 1.3 M) was then added to the autoclave and styrene (18.34 kg) was subsequently charged to the autoclave at a dosing rate of 2.3 kg/min. The temperature of the autoclave was maintained at about 50° C. for another 2 hours. During this time a second autoclave was charged with cyclohexane (282 kg), diethyl ether (25.26 kg) and butadiene (40 kg) and the temperature was maintained at 40° C. until transfer. The mixture was titrated with sec-BuLi after which 93.13 kg of the reaction mixture in autoclave 1 was transferred to autoclave 2. At 48 minutes after transfer methyltrimethoxysilane (30 g) was added. After completion of the coupling reaction, 2 mL methanol was added to the mixture. A sample of the resulting polymer was analysed by GPC and ¹H NMR as shown in Table 1 below.

Part of the polymer solution (40 kg) is charged to the reactor, heated to 50° C., the catalyst (100 mL) was added and the hydrogen pressure increased allowing the mixture to exotherm with minimal cooling. The catalyst concentration is 3 ppm Co/solution. The catalyst is prepared by diluting cobalt neodecanoate in cyclohexane and then slowly adding triethylaluminium to achieve a 2.1/1 molar ratio of Al/Co. When operating pressure is achieved (400 psi), another 250 kg of polymer solution was added at a rate of 2.3-2.4 kg/min while controlling the temperature at 80° C. During this period at two intervals 200 mL of catalyst solution was added. The hydrogenation reaction was sampled at regular intervals and analyzed by ¹H NMR to determine the degree of conversion of alkyl unsaturation. The determinations are made by integrating the appropriate peaks using methods well known to those of ordinary skill in the art of making such measurements. The reaction was run until NMR analysis of an aliquot showed a residual unsaturation of less than 0.1 meq/g. The catalyst is subsequently removed by washing with aqueous phosphoric acid, and the polymer is recovered via steam stripping, under conditions typical for hydrogenated polymers.

### EDF 9224

Cyclohexane (45.12 kg) was charged into a stainless steel autoclave (1). Diethyl ether (30 g) was added, followed by 1,1-diphenylethylene (6.59 kg). The mixture was titrated with sec-BuLi (1.3 M) to a visual endpoint while the temperature was maintained at 50° C. Excess sec-BuLi (372 mL, 1.3 M) was then added to the autoclave and styrene (7.63 kg) was subsequently charged to the autoclave at a dosing rate of 0.36 kg/min. The temperature of the autoclave was maintained at about 50° C. for another 3 hours. During this time a second autoclave was charged with cyclohexane (235 kg), diethyl ether (19.25 kg) and butadiene (21 kg) and the temperature was maintained at 40° C. until transfer. The mixture was titrated with sec-BuLi after which 49.75 kg of the reaction mixture in autoclave 1 was transferred to autoclave 2. At 40 minutes after transfer methyltrimethoxysilane (21 g) was added. After completion of the coupling reaction, methanol was added to the mixture. A sample of the resulting polymer was analysed by GPC and ¹H NMR as shown in Table 1 below.

Part of the polymer solution (41 kg) is charged to the reactor, heated to 65° C. with 400 psi H₂ pressure, the catalyst (100 mL) was added and the temperature increased to 75° C. The catalyst concentration is 3 ppm Co/solution. The catalyst is prepared by diluting cobalt neodecanoate in cyclohexane and then slowly adding triethylaluminium to achieve a 2.1/1 molar ratio of Al/Co. After 5 minutes, another 125 kg of polymer solution was added at a rate of 2.5 kg/min while controlling the temperature at 80° C. with a H₂ pressure of 400 psi. During the addition (at 23 minutes) another aliquot of catalyst solution (100 mL) was added. The hydrogenation reaction was sampled at regular intervals and analyzed by ¹H NMR to determine the degree of conversion of alkyl unsaturation. The determinations are made by integrating the appropriate peaks using methods well known to those of ordinary skill in the art of making such measurements. The reaction was run until NMR analysis of an aliquot showed a residual unsaturation of less than 0.1 meq/g. The catalyst is subsequently removed by washing with aqueous phosphoric acid, and the polymer is recovered via steam stripping, under conditions typical for hydrogenated polymers.

TABLE 1

| | Apparent | | | | | | |
|---|---|---|---|---|---|---|---|
| | Molecular | | | | | | |
| | Weight | Si/Li | CE | Vinyl | 1 Arm | 2 Arm | 3 and 4 Arm |
| EDF | 381 | 0.49 | 91 | 38 | 9 | 65 | 20 |
| 9214 | | | | | | | |
| EDF | 288 | 0.38 | 89 | 37 | 10 | 61 | 18 |
| 9224 | | | | | | | |

“Apparent Molecular Weight” values are in thousands,
“Si/Li” is the ratio of tetramethoxysilane coupling agent to s-BuLi initiator,
“CE” is coupling efficiency,
Vinyl refers to the 1,2-content of the butadiene portion of the polymer,
1 Arm is uncoupled diblock,
2 Arm is the linear triblock copolymer,
3 and 4 Arm polymers are radial in structure.

### Example 2

In this Example 2, various gels were made by using the block copolymer of the present invention and comparing them with gels made from block copolymers of the prior art. Soft gels were made by dissolving the polymer in Nyflex 222 (from Nynas), a paraffinic/naphthenic extending oil. Polymer E refers to a conventional linear, selectively hydrogenated SBS block copolymer prepared by sequential polymerization, i.e. an S-EB-S block copolymer having 33 weight percent styrene and a vinyl content of the butadiene prior to hydrogenation of 38%. Polymer F refers to a hydrogenated styrene/butadiene block copolymer composition prepared with a tetraethoxy silane coupling agent. EDF 9214 and EDF 9224 refer to block copolymers prepared according to the present invention as described in Example 1. The attached results in Table 2 show properties of four oil gels containing 6% weight polymer in a paraffinic/naphthenic extending oil. Gels 1 and 2 contain conventional SEBS polymers. Gel 3 contains a polymer like Polymer E except the endblocks are copolymers of 77%w S and 23%w DPE. Gel 4 contains a polymer like Polymer F except the endblocks are copolymers of 54%w S and 46%w DPE. Results show that Gels 3 and 4 have R&B softening points about 25° C. and about 35° C. higher than the softening points of Gels 1 and 2. The improved upper service temperature is also shown by the temperatures at which G′ and G″ are equal. Gels 3 and 4 have crossover temperatures which are about 40° C. higher and about 50° C. higher than the crossover temperatures of Gels 1 and 2.

The gels were made by first pretumbling about half the oil onto the crumb on the roller. The rest of the oil was then mixed in a sigma blade mixer. Gels #1, 2 and 3 were mixed at 350° F., while gel #4 was mixed at 370° F. Brookfield melt viscosity was measured with a #21 spindle. Viscosity did not depend strongly on rpm. All blends were clear except #4 which had a bluish haze.

TABLE 2

| Composition, % w | 1 | 2 | 3 | 4 |
|---|---|---|---|---|
| Nyflex 222 | 93.8 | 93.8 | 93.8 | 93.8 |
| Polymer E | 6 | | | |
| Polymer F | | 6 | | |
| EDF 9214 | | | 6 | |
| EDF 9224 | | | | 6 |
| Irganox 1010 | 0.2 | 0.2 | 0.2 | 0.2 |
| Ring & Ball Softening Pt. ° C. | 107 | 111 | 134 | 142 |
| DMA G′/G″ Crossover, ° C. | 126 | 126 | 167 | 178 |
| Melt Vis @ 150° C., Pa · s | 2.3 | 2.6 | 12 | 28 |
| Melt Vis @ 205° C., Pa · s | | | | 2.5 |

What is claimed:

1. An oil gel composition comprising 100 parts by weight of at least one hydrogenated block copolymer composition and about 300 to about 2000 parts by weight of an extending oil, wherein said hydrogenated block copolymer comprises an A-B-A, an (A-B)ₙ or an (A-B)ₙ-X copolymer wherein:
i. A comprises a polymer block of a monoalkenyl arene and one or more 1,1-diphenylethylenes or its derivatives of the formula I: 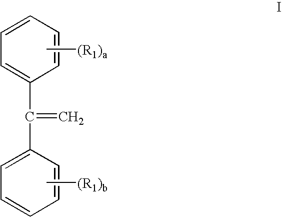
wherein R₁ is hydrogen or an alkyl of 1 to 22 carbon atoms, a is 0, 1, 2, 3, 4, or5 and b is 0, 1, 2, 3, 4, or 5.;
ii. B represents a polymer block of a hydrogenated conjugated diene;
iii. X represents the residue of coupling agent; and
iv. n is an integer from 2 to 30.

2. The oil gel composition according to claim 1 wherein the weight ratio of monoalkenyl arene to 1,1-diphenylethylene is from 97:3 to 30:70.

3. The oil gel composition according to claim 2 wherein said mono alkenyl arene is styrene, said 1,1-diphenylethylene is unsubstituted and said conjugated diene is selected from the group consisting of isoprene and butadiene.

4. The oil gel composition according to claim 3 wherein said conjugated diene is butadiene, and wherein prior to hydrogenation about 10 to about 80 mol percent of the condensed butadiene units in block B have 1,2-configuration.

5. The oil gel composition according to claim 3 wherein said coupling agent is an alkoxy silane coupling agent selected from the group consisting of tetraethoxy silane, tetramethoxy silane, tetrabutoxy silane, methyl trimethoxy silane, methyl triethoxy silane, phenyl trimethoxy silane and isobutyl trimethoxy silane.

6. The oil gel composition according to claim 5 wherein n is 2 to 4.

7. The oil gel composition according to claim 3 wherein said A blocks have a number average molecular weight of between about 5,000 and about 60,000, and wherein said B blocks have a number average molecular weight of between about 10,000 and about 200,000.

8. The oil gel composition according to claim 7 wherein the weight ratio of polymer block A to polymer block B is from 5/95 to 50/50.

9. The oil gel composition according to claim 8 wherein said extending oil is a paraffinic/naphthenic process oil.

10. The oil gel composition according to claim 9 wherein the amount of extending oil is between about 400 and about 1000 parts by weight.

11. The oil gel composition according to claim 1 also comprising up to 30 percent by weight of a filler, based on the total formulation.

12. An article prepared from the gel of claim 1.
